(19) United States
(12) Patent Application Publication
(10) Pub. No.: US 2006/0242149 A1
(43) Pub. Date: Oct. 26, 2006

(54) Medical demonstration

(76) Inventor: Gregory William Richard, Hunters Hill (AU)

Correspondence Address: FENWICK & WEST LLP, SILICON VALLEY CENTER, 801 CALIFORNIA STREET, MOUNTAIN VIEW, CA, 94041, US

(21) Appl. No.: 10/530,786

(22) PCT Filed: Oct. 8, 2003
(86) PCT No.: PCT/AU03/01325

§ 371 Date: Oct. 24, 2005

(30) Foreign Application Priority Data
Oct. 8, 2002 (AU) 2002951908

(51) Int. Cl. G06F 17/30

(52) U.S. Cl. 707/8

(57) ABSTRACT

The present invention provides a method of allowing medical practitioners to demonstrate the effects of a medical condition or a treatment to an individual. This is achieved by using a processing system to obtain image data in accordance with an input command received from the medical practitioner. The image data defines one or more images representing a medical condition or associated treatment, and these can be presented to the user on a display. Following this, annotations can be added to the displayed images, allowing the annotations to be used in explanation of a medical condition.

### BACKGROUND OF THE INVENTION

The present invention relates to a method and apparatus for allowing medical practitioners to demonstrate the effects of a medical condition, or a treatment to an individual.

### DESCRIPTION OF THE PRIOR ART

The reference to any prior art in this specification is not, and should not be taken as, an acknowledgement or any form of suggestion that the prior art forms part of the common general knowledge in Australia.

WO01/08076 describes a system that allows medical practitioners to demonstrate the effects of medical conditions and treatments to individuals. This is achieved by providing images or animations of the medical conditions and treatments. The images and animations are determined using wire frame models, and are created and/or checked by medically qualified personnel, to thereby ensure anatomical correctness.

However, whilst this system helps medical practitioner explain the effects of the medical condition or treatment, the functionality provided by this system is limited, and in particular, will only allow the medical practitioner to demonstrate conditions passively.

### SUMMARY OF THE PRESENT INVENTION

In a first broad form the present invention provides a method of allowing medical practitioners to demonstrate the effects of a medical condition or a treatment to an individual using a processing system, the method including causing the processing system to:
a) Obtain image data in accordance with an input command received from the medical practitioner, the image data defining one or more images;
b) Present the one or more of the images on a display; and,
c) Present annotations on the display in response to one or more input commands.

The image data can define one or more image sequences, in which case, the method typically includes causing the processing system to:
a) Present one or more of the images in the image sequence in response to an input commands;
b) Select a respective one of the images in response to an input command; and,
c) Present image annotations for the selected image.

The annotations generally include at least one of:
a) Text annotations; and,
b) Drawings annotations.

In this case, it will be appreciated that the drawing annotations may take a variety of forms, with the annotations also optionally being provided in a variety of colours. Additionally, other annotations, such as graphics, or the like may be used.

The method typically includes causing the processing system to superimpose the annotations on the respective image.

The method also typically includes causing the processing system to store the annotations in a store in accordance with an input command. This allows the stored annotations to form part of the individual's medical records.

In this case, the store can be coupled to one or more processing systems by a communications network. This allows selected medical practitioners to access the patients medical records via communications network using a respective one of the processing systems.

The method can include causing the processing system to store the annotations together with at least an indication of the respective image.

The method also usually includes causing the processing system to store the annotation as a respective image. However, the annotations may alternatively be stored in different forms.

The method generally includes causing the processing system to store additional information together with the annotations, the additional information including at least one of:
a) The patient identity;
b) The medical practitioner identity;
c) A diagnosis; and,
d) A time and/or date indication representative of when the annotations were created.

The processing system can be coupled to one or more end stations via a communications network. In this case, the method typically includes causing the processing system to:
a) Receive input commands from the end stations via the communications network; and,
b) Present the image(s) and the annotations to the medical practitioner using the end station.

In a second broad form the present invention provides a processing system for allowing medical practitioners to demonstrate the effects of a medical condition, or a treatment to an individual, the processing system including:
a) A store for storing image data, the image data defining one or more images;
b) An input for receiving input commands from the medical practitioner;
c) A display for displaying the images; and,
d) A processor, the processor being adapted to:
   i) Present one or more of the images on the display in response to an input command; and,
   ii) Present annotations on the display in response to one or more input commands.

The processing system can be adapted to store the annotations in accordance with an input command.

The processing system may be coupled to a database, the processing system being adapted to store the annotations in the database. The processing system can be coupled to the database via a communications network.

The processor and the store may be provided at a base station, the base station being coupled to one or more remote end stations via a communications system, the input and the display being formed from the end stations.

The processing system is generally adapted to perform the method of the first broad form of the invention.

In a third broad form the present invention provides a computer program product for allowing medical practitioners to demonstrate the effects of a medical condition, or a treatment to an individual, the computer program product including computer executable code which when executed on a suitable processing system causing the processing system to perform the method of the first broad form of the invention.

In a fourth broad from, the present invention provides apparatus for handling medical records, the records including a representation of a medical condition or treatment to be applied to an individual, the apparatus including:
a) A database; and,
b) A processor coupled to the database, the processor being adapted to:
   i) Determine the medical records; and,
   ii) Store the medical records in the database.

The processing system can be coupled to one or more end stations via a communications network, the processor being adapted to:
a) Receive a medical record request from the end station; and,
b) Transfer a selected medical record to the end station in accordance with the request.

The request can include an indication of the medical practitioner making the request, in which case the processor can be adapted to:
a) Compare the practitioner indication to practitioner data stored in a store, the practitioner data indicating authorisations for the viewing of medical records;
b) Determine if the medical practitioner is authorised to view the selected medical record; and
c) Transferring the medical record in accordance with a successful determination.

In this case, the medical records typically include an image together with one or more associated annotations, the medical record being generated in accordance with the methods of the first broad form of the invention.

Typically the processing system forms part of a processing system according to the second broad form of the invention.

The database can be coupled to one or more processing systems by a communications network, thereby allowing the selected medical practitioners to access the patients medical records via the database using the processing systems.

The processing systems are typically processing systems according to the first broad form of the invention.

### BRIEF DESCRIPTION OF THE DRAWINGS

An example of the present invention will now be described with reference to the accompanying drawings, in which:

FIG. 1 is a schematic diagram of an example of a system for implementing the present invention;

FIG. 2 is a flow chart outlining the process implemented by the processing system of FIG. 1;

FIGS. 3A, 3B and 3C are a flow chart detailing the process of FIG. 2;

FIG. 4A is an example of a menu generated by the processing system of FIG. 1 showing a number of different body systems;

FIG. 4B is an example of a menu outlining images, movies and stories that are available;

FIG. 4C is an example of annotation provided on a respective image by the processing system of FIG. 1;

FIG. 5 is a schematic diagram of a second example of a system for implementing the present invention; and,

FIG. 6 is a schematic diagram of one of the end stations of FIG. 5.

### DETAILED DESCRIPTION OF THE PREFERRED EMBODIMENTS

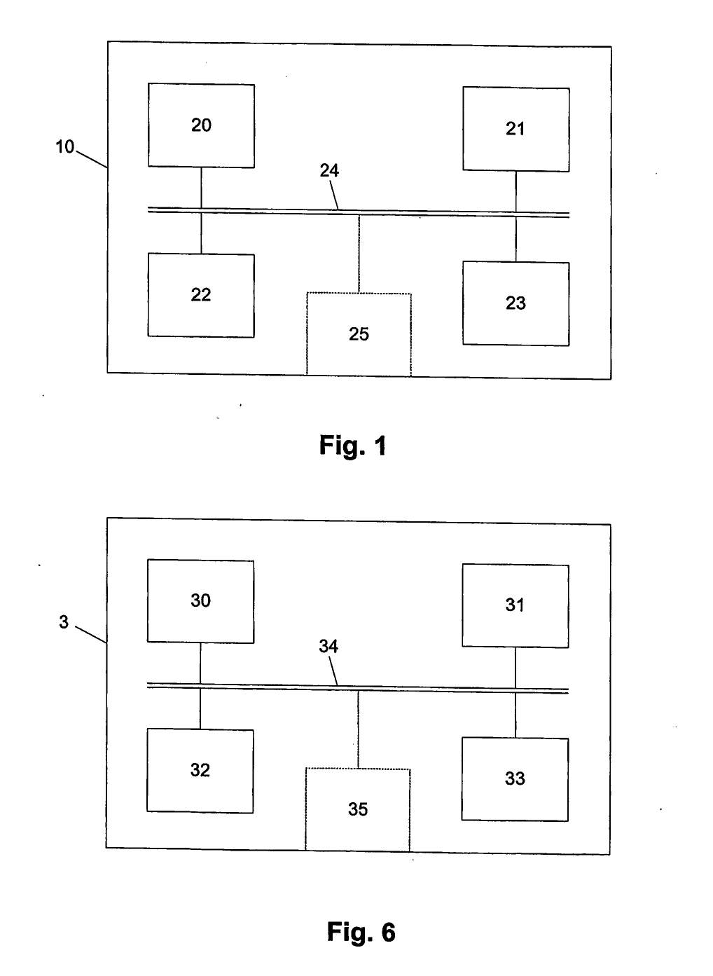

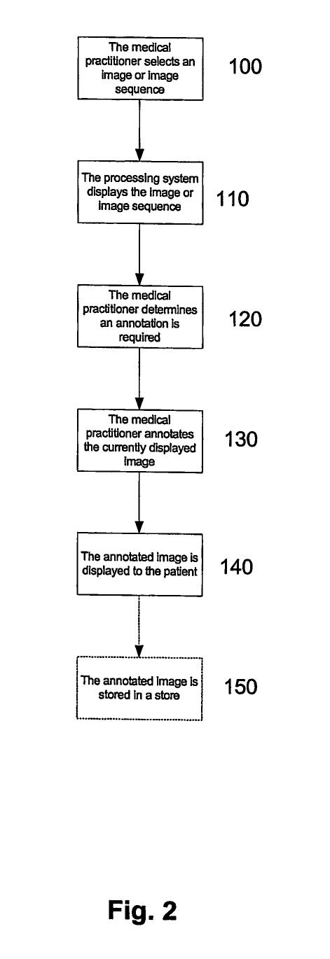

An example of the present invention will now be described with reference to FIGS. 1 and 2. In this example, a processing system is used to present one or more images to a patient to allow a medical practitioner, such as a Doctor or the like, to describe the effects of a medical condition or treatment.

An example of a processing system suitable for performing the present invention is shown in FIG. 1.

In particular, the processing system 10 generally includes at least a processor 20, a memory 21, and an input device 22, such as a keyboard, an output device 23, such as a display, coupled together via a bus 24 as shown. An optional external interface 25 may also be provided, as will be explained in more detail below.

In use, the processor 20 is adapted to present one or more images in accordance with image data stored in the memory 21, or a remote database 11, coupled to the external interface 25, as shown by the dotted lines. In use, presentation of the images is usually controlled in accordance with input commands provided by the user, which may also be used to allow the user to annotate one or more images. In general, the input commands are received either via the input device, or the external interface, with the images being presented on the output device, or being transferred to an external display means, via the external interface 25.

Accordingly, it will be appreciated that the processing system may be any form of processing system suitably programmed to perform the analysis, as will be described in more detail below. The processing system may therefore be a suitably programmed computer, laptop, palm computer, network or web server, or the like. Alternatively, specialised hardware or the like may be used.

In any event, an example of the operation of the processing system 10 in displaying images will now be described in overview with reference to FIG. 2.

As shown at step 100 the first stage is for the medical practitioner to select an image or image sequence to be displayed to an individual, such as a patient. This is achieved to allow the medical practitioner to describe the effects of a medical condition or a treatment.

Thus for example, if the medical practitioner wishes to demonstrate the operation of a respective system in the body, the medical practitioner can select an appropriate image or sequence of images to be displayed.

In general, each individual image corresponds to an image of a respective portion of the body shown in detail, for example in cross section, or the like. In the case of image sequences, each image sequence is usually a respective animation showing a respective potion of the body in operation.

The images or image sequences include images of healthy bodies in normal operation, bodies suffering from a medical condition, or bodies undergoing treatment. This aids the medical practitioner in explaining the effects of medical conditions, treatments and general body operation to patients.

The images and image sequences are generated using wire frame models, as described for example in WO01/08076. Accordingly generation of the images and image sequences will not be described in further detail.

Once the image or image sequence has been selected, the processing system operates to display the image or image sequence at step 110.

At step 120 the medical practitioner determines that an annotation to the image or image sequence is required. This may be used, for example, to highlight an area of interest to the respective patient, or to show the effect of the medical condition or treatment as this applies specifically to the individual. This may be required to help a patient remember details of the medical practitioners explanation, or the like, as will be described in more detail below.

At step 130, the medical practitioner annotates the currently displayed image. This may be performed once a respective image has been displayed or alternatively, partway through the display of an image sequence. In the latter case, the display of the image sequence is generally halted at the image currently being displayed.

At step 140, the medical practitioner can cause the processing system to display the annotated image to the patient allowing the doctor to explain particular aspects of a medical condition or treatment. This aids significantly in the patient's understanding of their condition or the treatment that is to be given to the patient. The annotated image may be provided to the patient in either a hard copy, presented on a display, or transferred to the patient electronically, via e-mail or the like.

In any event, at step 150 the annotated image may then optionally be stored in a store, allowing the medical practitioner to keep a record of the annotations that were shown to the patient.

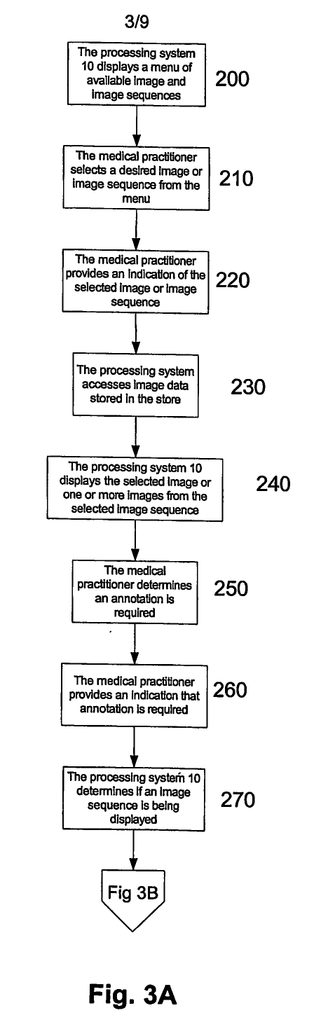

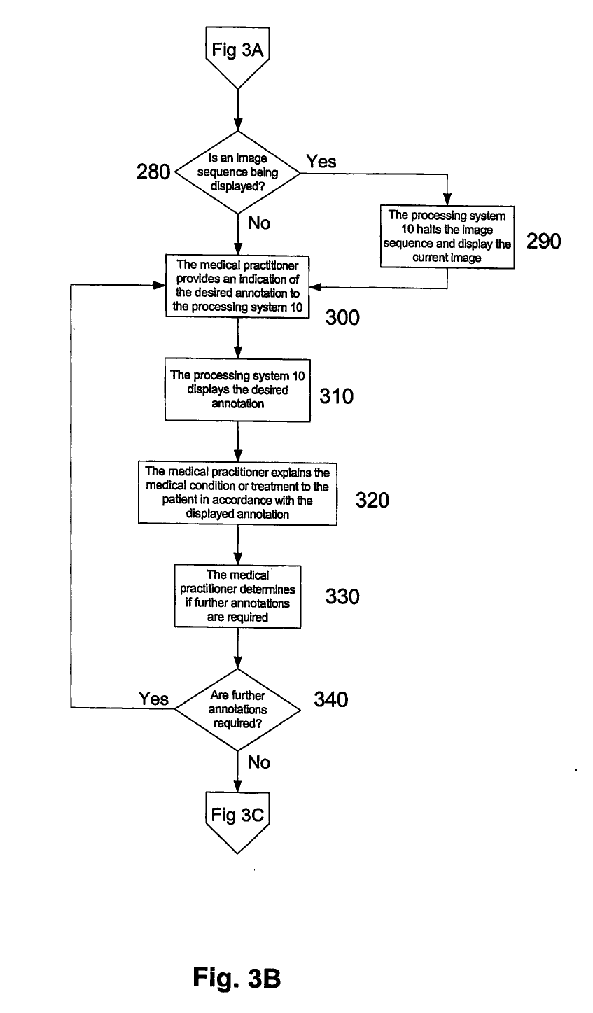

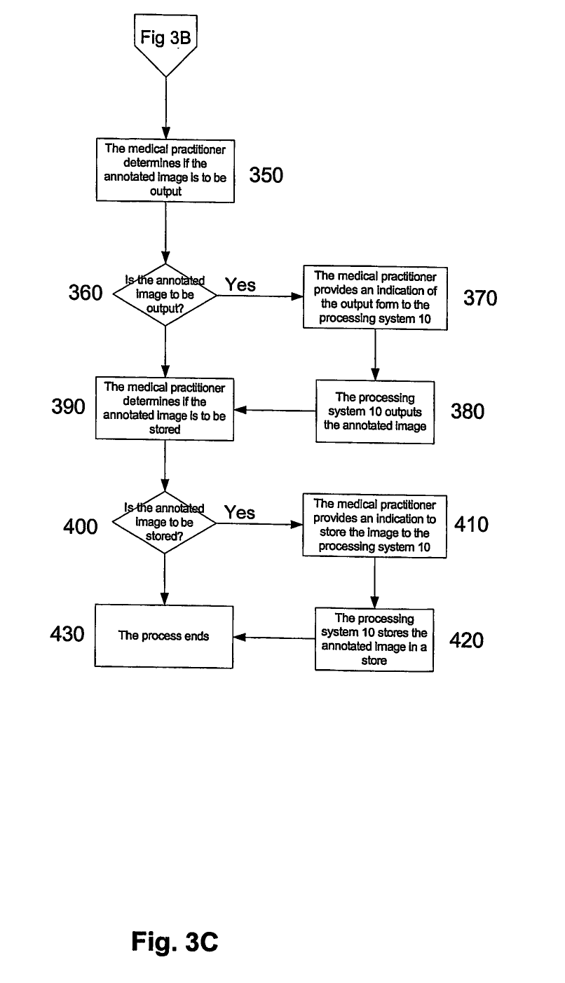

This process will now be described in more detail with respect to FIGS. 3A to 3C.

In particular, at step 200, the processing system 10 displays a menu of available image and image sequences to the medical practitioner. This may be achieved in a variety of ways depending on the specific implementation of the present invention.

Thus, for example, the processing system 10 can display a list of various medical conditions or treatments, allowing the medical practitioner to select the condition or treatment that is relevant to the patient. Alternatively, the processing system 10 can display a list of different body systems, such as the circulatory system, the nerve system, or the like.

At step 210 the medical practitioner selects a desired image or image sequence from the menu, and provides an indication of the selection to the processing system at step 220.

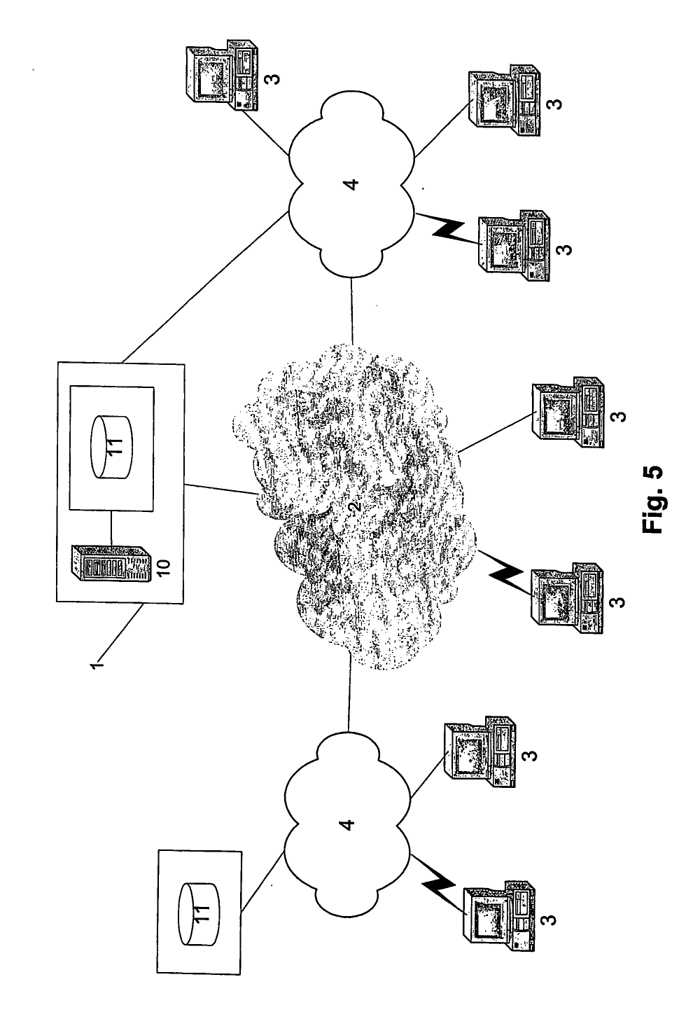

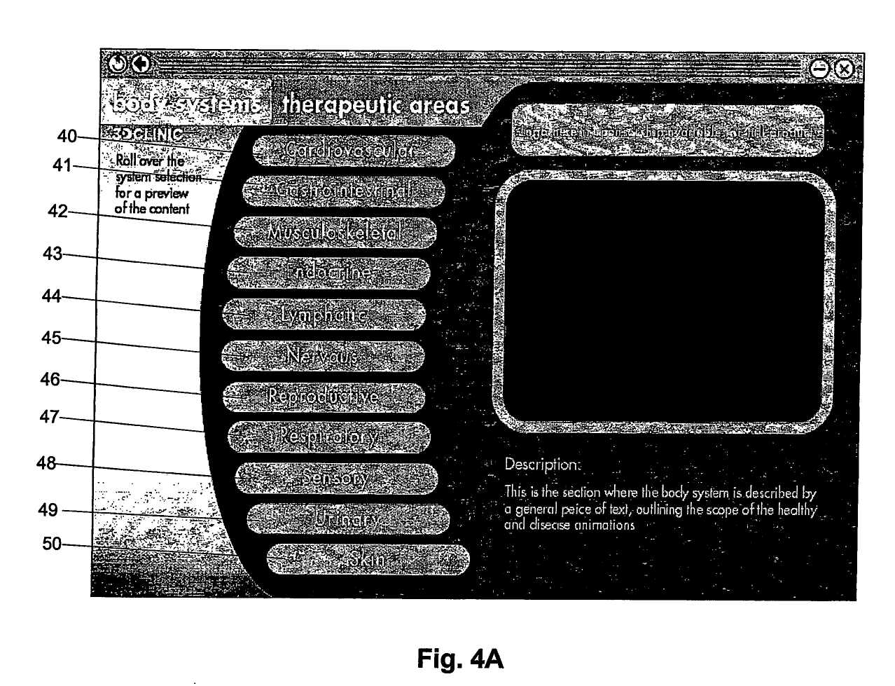

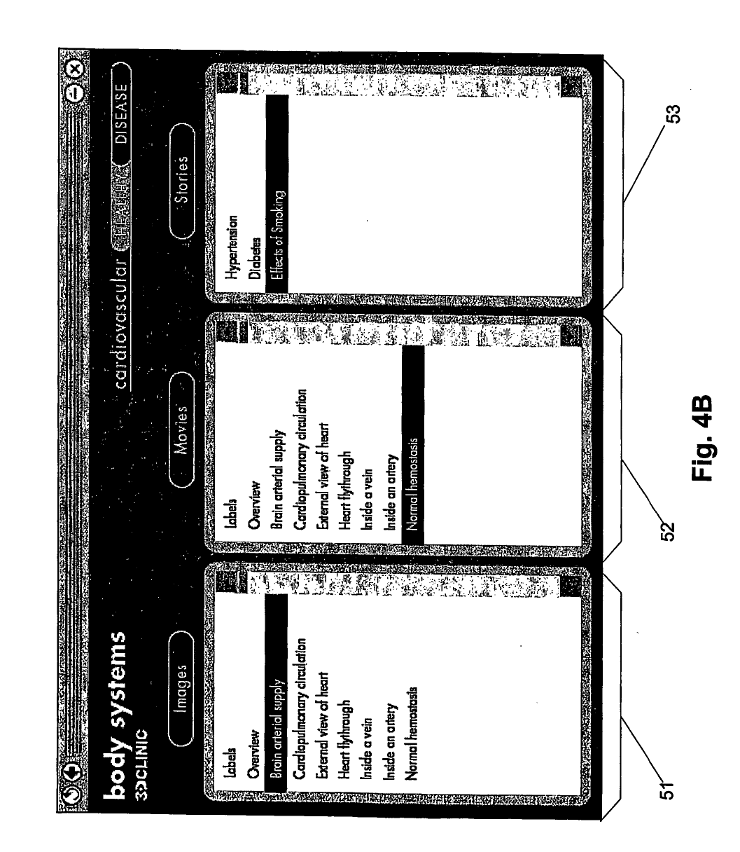

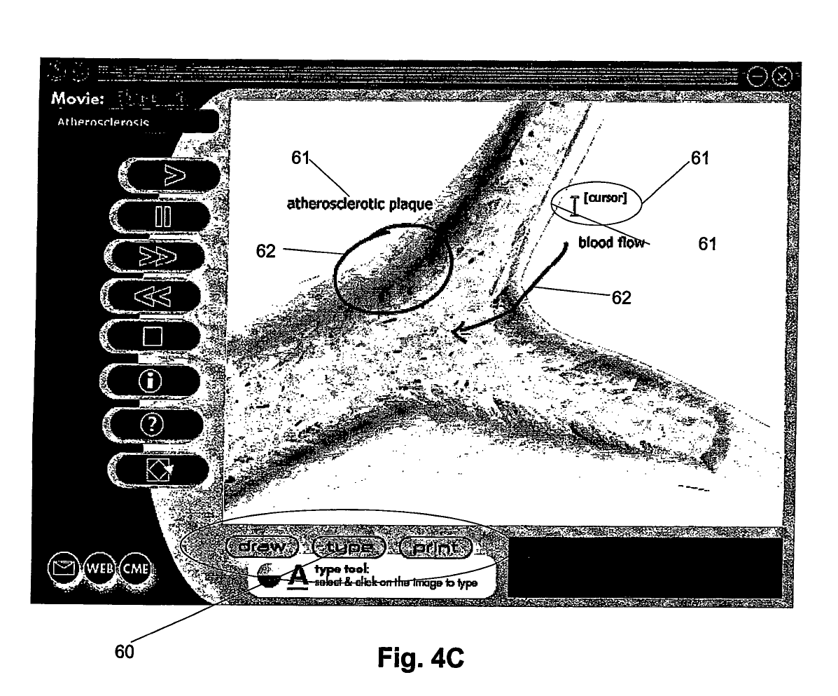

An example of the manner in which this is achieved is shown in FIGS. 4. As shown in FIG. 4A, the medical practitioner is initially presented with a number of images or text boxes, 40, 41, 42, . . . 50, each of which corresponds to a different body system. In general, the list will include details of at least one or more of the following systems:
Cardiovascular;
Gastrointestinal;
Musculoskeletal;
Endocrine;
Lymphatic;
Nervous;
Reproductive;
Respiratory,
Sensory,
Urinary; and,
Skin.

The medical practitioner selects an appropriate body system by positioning a cursor over the body system, which in turn causes additional detail of the body system to be displayed. Thus, for example, the medical condition may be a circulatory problem such as the build up of cholesterol. In this case, the medical practitioner selects the cardiovascular system 40 from the list of different body systems shown in FIG. 4A.

The processing system will then display an image or menu of the respective system, together with details of the respective medical treatments and conditions for which images are available.

Thus, in the case of the cardiovascular system, a representation of the cardiovascular system could be displayed. Alternatively, as shown in FIG. 4B, a menu can be displayed, with the menu listing various images 51, movies 52, or stories 53 of the different medical conditions and treatments that are available.

In this regard stories are used to explain the effects of a condition through a series of images and text.

In this case, the medical practitioner then selects a cholesterol build up example, such as peripheral vascular disease, again by placing the cursor over the respective indication, and making an appropriate selection.

It will be appreciated by those skilled in the art, that each indication may in turn include sub-indications, allowing further different categorisation of the images or image sequences to be displayed. Thus, for example, each indication could correspond to a respective portion of the displayed system, with the sub-indications corresponding to the effect of the medical condition and the effect of the treatment respectively.

Thus, for example, a first sub-indication could correspond to a sequence of images showing the operation of the circulatory system with cholesterol build up in place, with a second sub-indication showing the operation of a healthy circulatory system, progressing through an animation showing the build up of cholesterol within the circulatory system, together with the subsequent effect on the operation caused by the cholesterol build up.

Conversely, in the case of a treatment the image sequence could simply show the improvement in the operation of the circulatory systems as medication, or improved diet are used to treat the condition.

In order to achieve this, the processing system 10 accesses image data stored in the store at step 230, in accordance with the image or image sequence selected by the medical practitioner at 220. The image data corresponds to an image or image sequence, which is typically generated using a wire frame model, as described for example in WO01/08076.

In,this example, the store may comprise the memory 21 or a database, or the like, connected to the processing system via the external interface 25, or a CD-ROM, DVD, or other storage media.

In any event, at step 240 the processing system 10 displays the selected image or one or more images from the selected image sequence. Thus, if a medical practitioner selects an option corresponding to an image sequence, the processing will begin to display the image sequence in the form of an animation.

At step 250 the medical practitioner determines that annotation of the image or image sequence is required. This will typically occur whilst the medical practitioner is explaining the condition and or treatment to the patient.

Thus for example, it may become evident that the patient does not fully comprehend a certain aspect of the medical condition or treatment the medical practitioner is explaining. Accordingly, in this instance the medical practitioner can help by providing annotations on an image to help explain a point. In the event that the medical practitioner determines an annotation as required at step 250, the medical practitioner provides an indication that annotation is required at step 260.

This is typically achieved by selecting an annotation tool from an annotation tool menu displayed by the processing system 10, as shown for example at 60 in FIG. 4C. It will be noted that FIG. 4C is presented as a negative image to help improve the contrast of the annotations for the purpose of presentation herein only.

It will be appreciated, that an input command from the medical practitioner may be required to display the animation tool menu. The animation tools typically include tools such as:
Text annotations;
Drawing annotations including shapes, lines or free-handed drawings;
Verbal annotations;
Link annotations, to provide links to other information, such as hyperlinks to websites;

Having selected an annotation tool to thereby indicate that annotation is required at step 260, the processing system 10 determines if an image sequence is being displayed at step 270. If an image sequence is being displayed at step 280, the processing system 10 halts the image sequence and displays only the current image in the sequence at step 290.

Once a single static image is being displayed at step 300, the medical practitioner provides an indication of the desired annotation to the processing system 10. Thus, for example, if the medical practitioner has selected a text insert tool, the medical practitioner will be provided with a cursor that can be positioned on the image allowing the medical practitioner to input text which is then displayed superimposed on the image at the location of the cursor, at step 310. This is shown for example at 61 in FIG. 4C.

Alternatively, the medical practitioner may select a drawing tool, such as one used in drawing software applications. Again, the doctor will control the drawing tool to draw shapes or lines on the image at step 300 with the annotation being displayed at step 310. This is shown for example at 62 in FIG. 4C.

Other annotation tools can also be used as described above. Thus, in the case of verbal annotations, the medical practitioner will be able to record the provided explanation associated with a respective portion of the image. This allows the patient to replay the medical practitioner's explanation, for example by selecting a highlighted area of an electronic version of the image, which includes the record voice data associated therewith.

Similarly, in the case of link annotations, the medical practitioner may provide a link such as a hyperlink, or the like, which directs the user to a web site or the like which includes additional information relating to the condition and or treatment, or even further animations explaining the process in further detail.

It will be appreciated that in the cases of link and verbal annotations, it may only be possible for the patient to activate the annotations if the patient has an electronic copy of the annotated image, including the required data, as will be described in more detail below.

In any event, the medical practitioner explains the medical condition or treatment to the patient in accordance with the displayed annotation at 320. It will be appreciated that although this has been shown as a subsequent step, usually steps 300 and 310 are performed simultaneously at step 320 such that the medical practitioner explains the medical condition whilst providing the annotations.

At step 330 the medical practitioner determines if further annotations are required. Thus, this may occur if the patient still does not understand the process or if different types of annotation are required.

If further annotations are required, the medical practitioner will typically select a respective annotation tool, allowing the processing system to determine that further annotation is required at step 340. Accordingly, the process returns to step 300 where the medical practitioner again provides an indication of the desired annotation to the processing system 10.

Thus, it will be appreciated that the medical practitioner may first draw a number of lines on the image to highlight selected areas of the image at steps 300 to 310. Whilst performing this, the medical practitioner may explain various aspects of the conditional treatment to the patient, who then indicates that he will not remember this information.

Accordingly, at step 340, the medical practitioner selects the text annotation tool, indicating that further annotation is required. Accordingly, the process returns to step 300 allowing the medical practitioner to provide a text description that will act as a reminder to the patient.

Once it is determined that further annotations are not required, at step 340, then at step 350, the medical practitioner determines if the annotated image is to be output.

Thus, if the medical practitioner determines that the annotated image is to be output at step 360 the medical practitioner provides an indication of the output form to the processing system 10 at step 370, allowing the processing system 10 to output the annotated image at step 380.

Thus for example, the image may be printed and handed to the patient to be taken away. In this case, the medical practitioner may print a second copy of the document to be kept in the patient's medical records.

Alternatively, the annotated image may be output in electronic format, such as via e-mail, or on a transportable media, such as a floppy disc, CD-ROM, or the like, to allow the patient access to an electronic version of the annotated image. It will be appreciated that this is particularly useful in the event that the annotation is in the form of links such as hyperlinks to other electronic information, or if vocal annotations are provided.

Alternatively, if the annotated image is only used for the purpose of demonstration during the medical practitioner's explanation, it may be preferred not to output the image at all.

Once the annotated image is output, or if no annotated image is to be output, the medical practitioner determines if the annotated image is to be stored at step 390. This may be performed to allow the medical practitioner to store an indication of the annotations provided to the patient, or the like.

This could be particularly useful for use in patient records, or the like. This is particularly important in view of recent litigation in the medical industry that has resulted in medical practitioners being questioned regarding advice given to patients sometimes years after the advice was provided.

This also allows the medical practitioner to retain visual representations of the patient's condition on the various occasions when the medical practitioner has seen the patient. Thus for example, the medical practitioner may provide annotations indicating the patient's current health status, thereby allowing the annotated images to form the patient's medical notes.

Accordingly, if the annotated image is to be stored at step 400 the medical practitioner provides an indication to store the image to the processing system 10 at step 410. The processing system 10 stores the annotated image in a store at step 420.

Again, this may be achieved by storing the annotated image in the memory 21 or in a remote database coupled to the processing system via the external interface 25. Thus, for example, the medical practitioner may wish to store the annotated image in a store, such as a database, provided at the medical practitioners office. Alternatively, the storage may occur for example by placing the records on a physical media, such as a floppy disc, CD-ROM, or the like, which is then stored together with the patient's records, which may for example be stored as a paper file. Additionally, as will be described in more detail below, the document may be stored in a remote database, such as at a central location. In any event, it will be typical for the medical practitioner to provide an indication of the storage location at step 410.

At step 430 the process ends allowing the medical practitioner to select an alternative image or image sequence to be displayed either to the current patient or a subsequent patient.

It will be appreciated that the abovementioned process can be implemented using a variety of architectures. Thus, in the example described above the processing system 10 is used directly by the medical practitioner. This will therefore typically consist of a computer system, such as a personal computer, handheld PDA, laptop, or the like provided at the medical practitioner's office, such as at a doctor's surgery in the case of a medical practitioner being a GP.

In this case, the applications software and image data may be provided in the memory 21 to allow the abovementioned process to be performed. It will be appreciated that this is particularly useful for medical practitioners in demonstrating the effects of medical conditions and treatments on a day to day basis. For example, in a hospital environment, Doctors can be provided with handheld computers including a software application installed thereon for providing the required functionality. In this case, when the Doctor discusses a condition or treatment with a patient, this allows the Doctor to show the patient, with annotations, without requiring the patient to move to an appropriate terminal or other computer system.

However, network based systems, such as web or intranet LAN based systems or the like may also be implemented. An example of this is shown in FIG. 5 in which the processing system 10 is coupled to a database 11, provided at a base station 1. The base station 1 is coupled to a number of end stations 3 via a communications network 2, such as the Internet, and/or via communications networks 4, such as local area networks (LANs) 4. Thus it will be appreciated that the LANs 4 may form an internal network at a doctor's surgery, hospital, or other medical institution. This allows the medical practitioners to be situated at locations remote to the central base station 1.

In this example, whilst a single base station 1 is shown, it will be appreciated that a number of base stations 1, or database 11 may be provided, such that a respective base station 1 and/or database 11 may be provided associated with a LAN, such as a network in a hospital. In this case, the system may be adapted such that only end station 3 coupled to the respective LAN 4 are capable of accessing the respective base station 1 or database 11.

In any event, in use the end stations 3 must be adapted to communicate with the processing system 10 positioned at the base station 1, and the manner in which this is achieved will depend on the respective implementation. It will be appreciated that this allows a number of different forms of end station 3 may be used.

An example of a suitable end station is shown in FIG. 6. As shown the end station 3 includes a processor 30, a memory 31 and an input device 32 such as a keyboard, an output device 33 such as a display coupled together via a bus 34, as shown. An internal interface 35 is typically provided to allow the end station to be coupled to one of the communications networks 2, 4.

Accordingly, the end station 3 may be a computer, laptop, handheld computer such as a PDA, or the like. However, alternatively the device may be specialised hardware, or the like.

In use, the processor 30 is adapted to communicate with the processing system 10 provided in the base station 1 via the communications networks 2, 4 to allow the above described process to be implemented. Accordingly, it will be appreciated that if the communications network 2 is the Internet, this will typically be achieved by having the base station 1 present web pages to the medical practitioner on the end station 3. The medical practitioner can then navigate the web pages, such as through the use of hyperlinks thereby allowing the images to be selected and displayed. Similarly, annotation can be performed in a similar way.

In this instance it will be appreciated that the image data can be stored centrally at the database 11 allowing it to be transferred to the medical practitioner as required. Thus, in the case in which the end station 3 is a handheld device, this can be coupled to a central image store, such as the database 11 (which may be provided locally on the LAN 4), so that images can be downloaded to the device as required. This may be achieved via either wired or wireless connections, as will be appreciated by persons skilled in the art. In any event, this overcomes the need to store large amounts of image data on devices having limited memory capacity.

However, in some cases the quantity of the image data may be difficult to transmit over the network, such as the Internet in real time. Accordingly, the image data and information application software can alternatively be provided locally to each respective end station 3. This may be achieved by providing databases 11 locally to the end stations 3, for example on the communications networks 4, as shown. Alternatively, the image data could be stored in the memory 21 of each end station 3, or downloaded as required, for example from a CD-ROM, or the like.

When the medical practitioner is to store the annotated image, the annotated image can be transferred via the communications networks 2, 4 to a base station 1 for storage in the database 11. Accordingly, it will be appreciated that in this later example the base station 1 is simply used to centrally store the annotated images, with the end stations 3 operating as the processing system described in FIG. 1. From this it will be appreciated that the end stations 3 may provide equivalent functionality to the processing system 10 described in FIG. 1, by having the processor 30 execute appropriate applications software, which may be stored in the memory 31, or accessed from an external source, such as a CD-ROM, DVD, or the like.

In any event, regardless of whether the image data is stored centrally at the base station 1, or locally at the end stations 3, the architecture shown in FIG. 5 allows the end stations 3 to store the annotated images at a central location. This has a number of benefits.

In particular, this allows different medical practitioners to share information. Thus for example, if a patient moves from one GP to another GP, the new GP could access any patient's medical records that are stored at the database 1.

Alternatively, the annotated images and/or medical records may be stored at the database 11 for subsequent reference in legal actions. This is particularly useful as the provision of a centrally stored image could avoid subsequent manipulation of the image by the medical practitioners, thereby helping ensure the accuracy of information that may be supplied in a Court action. Accordingly, in this instance the base station 1 may be provided at an insurance company, a professional medical body, or the like, for use in subsequent legal disputes.

Furthermore, the central storage of annotated images may be used as a back-up, to thereby ensure that copies of the annotated images are not lost, for example due to failure of the medical practitioners storage systems.

In the event that annotated images are to be viewed by the users of the end stations 3, it is important that access to the annotated images is only provided to authorised users. In particular, it is generally undesirable for third parties to be able to obtain copies of individual's medical records, as these might be used for undesirable purposes.

Accordingly, the processing system 10 typically maintains a list of medical practitioner identifiers, together with an indication of the annotated images they are entitled to view.

Thus, medical practitioners may be limited to only viewing annotated images they have created and/or submitted. Alternatively, if a patient moves between GP, then permission to view the annotated images may be removed from one GP and transferred to another GP.

It will be appreciated that when the medical practitioners need to view an annotated image stored in the database 11, the medical practitioner will typically have to provide an indication of their respective identifier to the base station 1. The base station 1 will then validate the identifier, for example, through the use of a password system, biometric data, or the like, as will be appreciated by persons skilled in the art. This is performed to confirm that the user supplying the identifier is the medical practitioner to whom the identifier has been assigned.

This allows the base station 1 to determine the annotated images the respective medical practitioner is entitled to view. The medical practitioner can then select the required annotated image, which will then be transferred to the end station 1, for subsequent display. The annotated image can then also be output from the end station 3, in a manner similar to that described above with respect to FIG. 3C.

Thus, it will be appreciated that the above described network configuration, which is for the purpose of example only and is not intended to be limiting, may be used to allow image data to be retrieved from a central repository, such as the database 11, to allow image data representing annotated images to be stored centrally in a repository, or a combination of either of these modes of operation.

Variations

A number of additional developments can also be incorporated into the process outlined above.

Thus, for example, the annotated images may be provided with a time and date stamp, that indicates the time and date on which the annotations were created. This can be achieved by having the processing system 10, or the end station 3 encoded an indication of the time and date of the annotations within the image before it is stored. This time and/or date stamp can be encrypted using a predetermined encryption algorithm, thereby preventing the subsequent alteration of the time and/or date stamp.

The annotated images are typically marked with predetermined information, including the time and date at which the annotations are made, the name of the patient (or an appropriate patient identifier if confidentiality is an issue, as described below), and the name of the demonstrating medical practitioner. Additionally, or alternatively, other information may also be provided, such as the patient's medical record number, medicare number, NHS number, or private health insurance scheme reference number.

This information can be used for reference purposes, for example as evidence of a consultation, the information provided to the patient therein, and the medical practitioner that provided the advice. It will be appreciated that this is of significant use in monitoring medical practitioners and is also useful for any subsequent legal claims that may occur.

When the annotated images are stored, this can be achieved in a number of ways. Thus, for example, it is possible to form new image data representing the image and the superimposed annotations, with the new image data being stored.

Alternatively, it is possible to store data representing the annotations made, together with an indication of the image to which the annotations were applied. Thus, for example, in this latter case, as the image data is already stored, the annotations can be stored as annotation data, including a cross reference to the image data. When the annotated image is to be viewed in due course, the annotation data can be retrieved by either the processing system 10, or the end station 3, which then determine the respective image data from the indication stored in the annotation data. This allows the annotated image to be reconstructed from the annotation and image data. It will be appreciated that this will reduce storage requirements for the annotated images.

It will be appreciated that if the annotated images, and/or medical records are stored centrally in a database 11, there are issues surrounding the security of the data. In particular, it will be undesirable for the information to be accessed by third parties, which may allow the information to be used unlawfully.

Accordingly, the annotated images may be stored in an encrypted format. This can be achieved by having encryption performed by either the processing system 10, or the end station 3, depending on the respective implementation of the invention. Thus, for example, each medical practitioner may encrypt any annotated images they create using a respective encryption algorithm. This can be used to ensure that only the medical practitioner creating an annotated image can view the annotated image.

Additionally or alternatively, the annotated images can be encrypted centrally. This can be used to help ensure that the annotated images cannot be unlawfully viewed by third parties. In this case, when the annotated images are to be retrieved by a medical practitioner, the annotated image may be decrypted either before or after being transferred to the medical practitioner's end station 3.

Furthermore, the annotated images may be stored in the database associated with a patient identifier representative of the respective patient. The identifier may be in any suitable form, such as a alphanumeric code, and may be based on existing patient information, such as the patient name, medicare number, NHS number, or the like. Thus, for example, the identifier can be generated from patient information using a predetermined algorithm, or the like. By using a one way algorithm, this allows the patient identifier to be determined from patient details, but not for the patient details to be determined from a patient identifier.

A mapping between a respective patient identifier and the corresponding patient can be stored in an alternative location, such as on the medical practitioner's end station 3. This may be achieved through the use of a look-up table including an indication of the patient name for each identifier, or alternatively may be achieved be storing details of the algorithm used to generate the identifier.

In this instance, even if unlawful access to the database 11 were obtained, then any third parties would be unable to determine the patient to which each annotated image referred without also obtaining details of the mapping of the patient identifier to the patient. As this is typically stored in a different location, such as at a Doctor's office, hospital, or the like, and is not generally provided at the same location as the central storage facility, this increases the difficulty for third parties attempting to determine to whom a record belongs. In particular, the third party would typically require access to both the central repository and the mapping. Furthermore, if the mapping were not stored in electronic format, this would further hamper the ability of any third party to determine which annotated image corresponds to which patient.

Persons skilled in the art will appreciate that numerous variations and modifications will become apparent. All such variations and modifications that become apparent to persons skilled in the art should be considered to fall within the spirit and scope that the invention broadly appearing before described.

1) A method of allowing medical practitioners to demonstrate the effects of a medical condition or a treatment to an individual using a processing system, the method including causing the processing system to:
a) Select a disease or condition, in accordance with an input command received from the medical practitioner;
b) In accordance with the selection, obtain image data, from predetermined image data stored in a store, the image data defining one or more modelled images;
c) Present the one or more of the images on a display; and, d) Present annotations on the display in response to one or more input commands.

2) A method according to claim 1, the image data defining one or more image sequences, the method including causing the processing system to:
a) Present one or more of the images in the image sequence in response to an input commands;
b) Select a respective one of the images in response to an input command; and,
c) Present image annotations for the selected image.

3) A method according to claim 2, wherein the image sequence is animated.

4) A method according to claim 1, the annotations including at least one of:
a) Text annotations; and,
b) Drawings annotations.

5) A method according to claim 1, the method including causing the processing system to superimpose the annotations on the respective image.

6) A method according to claim 1, the method including causing the processing system to store the annotations in a store in accordance with an input command.

7) A method according to claim 6, the stored annotations forming part of the individual's medical records.

8) A method according to claim 7, the store being coupled to one or more processing systems by the communications network, the method including allowing selected medical practitioners to access the patients medical records via communications network using a respective one of the processing systems.

9) A method according to claim 6, the method including causing the processing system to superimpose the annotations on the respective image, and store the annotations together with at least an indication of the respective image.

10) A method according to claim 6, the method including causing the processing system to store the annotation as a respective image.

11) A method according to claim 6, the method including causing the processing system to store additional information together with the annotations, the additional information including at least one of:
a) The patient identity;
b) The medical practitioner identity;
c) A diagnosis; and,
d) A time and/or date indication representative of when the annotations were created.

12) A method according to claim 1, the processing system being coupled to one or more end stations via a communications network, the method including causing the processing system to:
a) Receive input commands from the end stations via the communications network; and,
b) Present the image(s) and the annotations to the medical practitioner using the end station.

13) A method according to claim 1, wherein the modelled images are wine-frame modelled.

14) A method according to claim 1, wherein the images are pre-defined computer generates images.

15) A method of allowing medical practitioners to demonstrate the effects of a medical condition, or a treatment to an individual, the method being substantially as hereinbefore described.

16) A processing system for allowing medical practitioners to demonstrate the effects of a medical condition, or a treatment to an individual, the processing system including:
a) A store for storing image data, the image data defining one or more modelled images;
b) An input for receiving input commands from the medical practitioner;
c) A display for displaying the images; and,
d) A processor, the processor being adapted to:
i) Present one or more of the images on the display in response to an input command; and,
ii) Present annotations on the display in response to one or more input commands.

17) A processing system according to claim 16, the processing system being adapted to store the annotations in accordance with an input command.

18) A processing system according to claim 17, the processing system being coupled to a database, the processing system being adapted to store the annotations in the database.

19) A processing system according to claim 18, the processing system being coupled to the database via a communications network.

20) A processing system according to claim 16, the processor and the store being provided at a base station, the base station being coupled to one or more remote end stations via a communications system, the input and the display being formed from the end stations.

21) A processing system according to claim 16, the processing system being adapted to perform the steps of:
a) Select a disease or condition, in accordance with an input command received from the medical practitioner;
b) In accordance with the selection, obtain image data, from predetermined image data stored in a store, the image data defining one or more modelled images;
c) Present the one or more of the images on a display; and,
d) Present annotations on the display in response to one or more input commands.

22) (canceled)

23) A computer program product for allowing medical practitioners to demonstrate the effects of a medical condition, or a treatment to an individual, the computer program product including computer executable code which when executed on a suitable processing system causing the processing system to perform the steps of:
a) Select a disease or condition, in accordance with an input command received from the medical practitioner;
b) In accordance with the selection, obtain image data, from predetermined image data stored in a store, the image data defining one or more modelled images;
c) Present the one or more of the images on a display; and,
d) Present annotations on the display in response to one or more input commands.

24) An apparatus for handling medical records, the records including a representation of a medical condition or treatment to be applied to an individual, the apparatus including a processing system, having:
a) A database; and,
b) A processor coupled to the database, the processor being adapted; and,
i) Determine the medical records; and,
ii) Store the medical records in the database;
wherein the medical records include an image together with one or more associated annotations, the medical records being generated by a second processing system, wherein the second processing system is adapted to:
a) Obtain image data in accordance with an input command received from a medical practitioner, then image data defining one or more images;
b) Present the one or more of the images on a display; and,
c) Present annotations on the display in response to one or more input commands.

25) The apparatus of claim 23, wherein the second processing system is the processing system.

26) Apparatus according to claim 23, the processing system being coupled to one or more end stations via a communications network, the processor being adapted to:
a) Receive a medical record request from the end station; and,
b) Transfer a selected medical record to the end station in accordance with the request.

27) Apparatus according to claim 23, the request including an indication of the medical practitioner making the request, the processor being further adapted to:
a) Compare the practitioner indication to practitioner data stored in a store, the practitioner data indicating authorisations for the viewing of medical records;
b) Determine if the medical practitioner is authorised to view the selected medical record; and
c) Transferring the medical record in accordance with a successful determination.

28) Apparatus according to claim 23, the medical records including an image together with one or more associated annotations, the medical record being generated by causing the processing system to:
a) Select a disease or condition, in accordance with an input command received from the medical practitioner;
b) In accordance with the selection, obtain image data, from predetermined image data stored in a store, the image data defining one or more modelled images;
c) Present the one or more of the images on a display; and,
d) Present annotations on the display in response to one or more input commands.

29) Apparatus according to claim 23, the processing system forming part of a processing system including:
a) A store for storing image data, the image data defining one or more modelled images;
b) An input for receiving input commands from the medical practitioner;
c) A display for displaying the images; and,
d) A processor, the processor being adapted to:
i) Present one or more of the images on the display in response to an input command; and,
ii) Present annotations on the display in response to one or more input commands.

30) Apparatus according to claim 23, the database being coupled to one or more processing systems by a communications network, thereby allowing the selected medical practitioners to access the patients medical records via the database using the processing systems.

31) Apparatus according to claim 29, the processing systems being processing systems including:
a) A store for storing image data, the image data defining one or more modelled images,
b) An input for receiving input commands from the medical practitioner;
c) A display for displaying the images; and,
d) A processor, the processor being adapted to:
i) Present one or more of the images on the display in response to an input command; and,
ii) Present annotations on the display in response to one or more input commands.

32) (canceled)
